(19) United States
(12) Patent Application Publication
(10) Pub. No.: US 2008/0095565 A1
(43) Pub. Date: Apr. 24, 2008

(54) Printer With Platen Support Device for Linerless Media and Associated Method

(75) Inventor: Frank Ray, Crystal Lake, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/828,011

(22) Filed: Jul. 25, 2007

Related U.S. Application Data
(60) Provisional application No. 60/862,517, filed on Oct. 23, 2006.

(51) Int. Cl. B41J 11/04

(52) U.S. Cl. 400/617

(57) ABSTRACT

The present invention provides an improved printer and an associated platen support device and method for printing a linerless media. The platen support device, which is adapted for contacting an adhesive surface of a linerless media in a printer, includes support rails disposed proximate a platen roller. The platen roller is configured to rotate so that an outer surface of the roller engages the adhesive surface of the linerless media. The support rails are disposed proximate the ends of the roller and extend in a direction perpendicular to the axis of the platen roller to define a support surface for supporting the linerless media and preventing the media from wrapping around the platen roller.

### CROSS REFERENCE TO RELATED APPLICATION

This application is related to commonly owned copending Provisional Application Ser. No. 60/862,517, filed Oct. 23, 2006, incorporated herein by reference in its entirety, and claims the benefit of its earlier filing date under 35 U.S.C. 119(e).

### BACKGROUND OF THE INVENTION

1. Field of the Invention

This invention relates to electronic label printing, and more particularly relates to the electronic printing of linerless labels.

2. Description of Related Art

As with many other manufacturing pursuits, it is desirable to reduce the quantity of waste produced during label printing. Such waste reductions limit the negative environmental impact attributable to label printing processes and further reduce manufacturing costs. To this end, linerless labels were developed. Linerless labels are those labels that are printed and used without conventional release layers or liners. Liners are conventionally used to support pressure sensitive adhesive labels as they move through a printer. Liners protect the adhesive surface of the label from environmental contaminants and also reduce the incidence of printer binding or jamming due to undesired adhesion of the labels to various printer components. Unfortunately, however, liners account for considerable waste as they are necessarily discarded as the labels are used.

FIG. 1 is a schematic illustration of a linerless label printing process according to the known prior art. The depicted process is performed within a conventional thermal printer system 10. The printer system 10 includes a thermal print head 30, a platen drive roller 20, and a linerless label supply 12. The linerless label supply 12 includes a continuous web of linerless label media 15 that is coated on one surface 18 with a pressure sensitive adhesive. The opposite surface of the linerless label media 15 is a printable surface 16. One or more idler rollers 14 may be provided to guide the label media 15 along a feed path from the supply 12 to the platen roller 20. In some applications, spring loaded dancers, rollers, plates, rods, and the like (not shown) may be provided to maintain sufficient tension in the linerless label media 15. During one type of thermal printing, namely, thermal transfer printing, the printable surface 16 is configured to receive a pigment (e.g., resin, wax-resin, etc.) that is transferred from a ribbon supply (not shown). Alternatively, other types of printing can be used, such as direct thermal printing in which a thermal print head 30 directly contacts the printable surface 16 of the label, thus, triggering a chemical or physical change in a thermally sensitive dye covering at least a portion of the printable surface 16 of the label.

In either thermal transfer printing or direct thermal printing applications, the web of linerless label media 15 is routed along the feed path from the supply roll 12 to a print position located beneath the thermal print head 30. Idler rollers 14, spring biased dancers, and other similar devices may be provided to manipulate the linerless label media 15 through the printer. These devices are generally designed to contact only the printable surface 16 of the linerless label media 15 as shown, thereby reducing the likelihood that the idler rollers or other devices will adhere to the adhesive surface 18 of the label media. Any such adhesion may undesirably bind or jam the printer.

The continuous web of linerless label media 15 is pulled through the printer system 10 by a platen roller 20 that is often powered by a stepper motor (not shown). Typically, the linerless label supply 12 is moderately biased to oppose the driving force produced by the platen roller 20. More particularly, the label supply 12 is generally biased to resist removal of the label media 15 from the label supply 12 by a fractioning device, clutch, or other similar mechanism (not shown). This bias maintains tension in the web of linerless label media 15 as it is pulled through the printer by the platen roller 20. Unlike idler rollers 14, the platen roller 20 is designed to contact the adhesive surface 18 of the linerless label media 15 as shown. To prevent adhesion between the platen roller 20 and the linerless label media 15, the platen roller 20 includes an adhesive release coating such as silicone, plasma coating, or other similar materials known in the art.

In various prior art applications, the print head 30 is positioned immediately above the platen roller 20. In fact, the print head 30 is generally configured to pinch the linerless label 15 between the print head 30 and the apex of the platen roller 20 as shown. This pinching or compressive force provides adequate print quality and in some applications ensures that a sufficient tension is maintained along the continuous web of linerless label media 15. Once printed, the printed portion of the linerless label is advanced outwardly by the platen roller 20 to extend over a tear bar 35 in a removal position as shown. The printed linerless label remains cantilevered over the tear bar 35 until removed by a user. In some applications, a sensor is positioned adjacent the tear bar 35 to detect the removal of the printed linerless label. In the depicted application, the sensor is a light sensor including an emitter 32 and a receiver 34. The emitter transmits a beam of light upwardly toward the receiver 34, which is positioned generally adjacent the print head 30 as shown. If a printed label has been removed, the beam of light reaches the receiver 34. If the printed label has not been removed and remains in the removal position, the beam of light is blocked by the printed label. In this way, the printer processor may determine for subsequent print registration whether a printed label is awaiting removal or has already been removed.

Relative to a conventional label media with a liner, the use of linerless label media as described above can reduce waste, manufacturing cost, and the need for removal and disposal of the liner by the user. However, the exposed adhesive surface of the linerless label media can undesirably adhere or stick to components of the printer, thereby complicating the operation of the printer. In particular, the adhesive surface of the linerless label media can adhere to the platen roller 20, the tear bar 35, and any other components that contact the adhesive surface, such as other rollers, dancers, plates, rods, and the like that are provided to guide the label media, apply tension to the media, or otherwise contact the media. For example, if the adhesive surface adheres to the platen roller 20 (or another roller in the printer) and is not released therefrom, the linerless label media can become wrapped around the roller, thereby jamming (and possibly damaging) the printer. Adhesion of the media to printer components or to itself can also increase the resistive load on the printer and/or foul the components or the media. Such excessive sticking of the linerless label media can result from normal use and can be exacerbated by certain operating conditions, such as extreme temperatures, high humidity, other environmental conditions, adhesive deposits, prolonged pauses in operation, and the like.

Accordingly, there exists a need for an improved printer and platen support device for supporting linerless media along the feed path of a printer while reducing the likelihood of the media adhering to the printer components and wrapping around the platen roller or otherwise deviating from the feed path.

### BRIEF SUMMARY OF THE INVENTION

The present invention provides an improved platen support device for contacting an adhesive surface of a linerless media in a printer. According to one embodiment, the platen support device includes a platen roller and first and second support rails proximate thereto. The platen roller is configured to rotate about a longitudinal axis, e.g., to rotate and drive the linerless media along the feed path. The platen roller extends longitudinally in the direction of the axis between first and second ends. An outer surface defined by the platen roller is configured to engage the adhesive surface of the linerless media. Each of the support rails is disposed proximate a respective one of the ends of the platen roller, extends in a direction perpendicular to the axis of the platen roller, and defines a support surface for supporting the linerless media.

The present invention also provides an associated linerless label printer for advancing a linerless media along a feed path through the printer and printing on a printable surface of the linerless media opposite an adhesive surface of the linerless media. The printer includes a print head disposed along the feed path and configured to print on the printable surface of the linerless media. A rotatable platen roller is configured to define a nip with the print head for receiving the linerless media. The platen roller extends longitudinally between first and second ends and defines an outer surface configured to engage the adhesive surface of the linerless media. A first support rail is disposed proximate the first end of the platen roller, and a second support rail is disposed proximate the second end of the platen roller. Each of the support rails extends longitudinally in the direction of the feed path and defines a stationary support surface for supporting the linerless media. A length of the platen roller between its first and second ends can be shorter than a width of the linerless media. The support surface of each support rail is configured to slidably support the media when the media is engaged to the platen roller and moving along the feed path.

In one embodiment, each support rail extends longitudinally along the feed path to a face plate downstream of the platen roller such that the rails guide the media onto the face plate. One or both of the rails can be formed integrally with the face plate and/or adjustably mounted so that the distance between the support rails can be adjusted to accommodate various widths of media. Each support rail can define a tapering cross-sectional shape such that each support surface is an edge extending in the direction of the feed path. In some embodiments, the printer can also include other members or features for supporting the media, such as a flow device structured to provide a low-pressure flow that buoyantly supports the linerless media in a cantilevered orientation downstream of the platen roller, or a secondary roller or bumper disposed immediately downstream from the platen roller for dislodging the printed linerless from the platen roller.

According to another embodiment of the present invention, a method is provided for operating a printer with a linerless media having a first side defining a printable surface and an opposite side defining an adhesive surface. A rotatable platen roller is provided along a feed path of the printer. First and second support rails are provided at the first and second ends, respectively, of the platen roller. Each support rail extends longitudinally in the direction of the feed path and defines a support surface for supporting the linerless media. The linerless media is advanced along the feed path so that the adhesive surface contacts an outer surface of the platen roller as opposite edges of the linerless media slide against the support surfaces. For example, the linerless media can be advanced through a nip defined between the rotatable platen roller and a print head so that the print head can print on the printable surface of the media.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic illustration of a linerless label printer according to the known prior art;

FIG. 2 is a perspective view illustrating a linerless media printer according to one embodiment of the invention, shown with the print head removed for illustrative clarity;

FIGS. 3-6 are perspective views illustrating portions of the linerless media printer of FIG. 2;

FIGS. 7-8 are elevation views partially illustrating the front of the linerless media printer of FIG. 2;

FIG. 9 is an elevation view illustrating a side of the face plate of the linerless media printer of FIG. 2;

FIG. 10 is a perspective view partially illustrating one of the support rails and the platen roller of the linerless media printer of FIG. 2;

FIG. 11 is a side view partially illustrating one of the support rails and the platen roller of the linerless media printer of FIG. 2;

FIG. 12 is a top view of the platen roller, face plate, and support rails according to another embodiment of the present invention, in which one of the support rails is adjustably secured relative to the face plate;

FIG. 13 is a schematic illustration of a linerless label printer according to another embodiment of the invention, wherein the linerless label is illustrated in a registration position;

FIG. 14 is a schematic illustration of a linerless label printer according to one embodiment, wherein the linerless label is configured in a print position;

FIG. 14A is a detail view of the linerless label printer of FIG. 13, taken along Detail Circle 14A of FIG. 14;

FIG. 15 is a schematic illustration of a linerless label printer according to one embodiment, wherein the linerless label is configured in an advancing position between the print position and the removal position;

FIG. 15A is a schematic illustration of a linerless label printer according to another embodiment, wherein the linerless label is configured in an advancing position between the print position and the removal position; and

FIG. 16 is a schematic illustration of a linerless label printer according to one embodiment of the invention, wherein the printed linerless label is buoyantly supported in the removal position by a flow device.

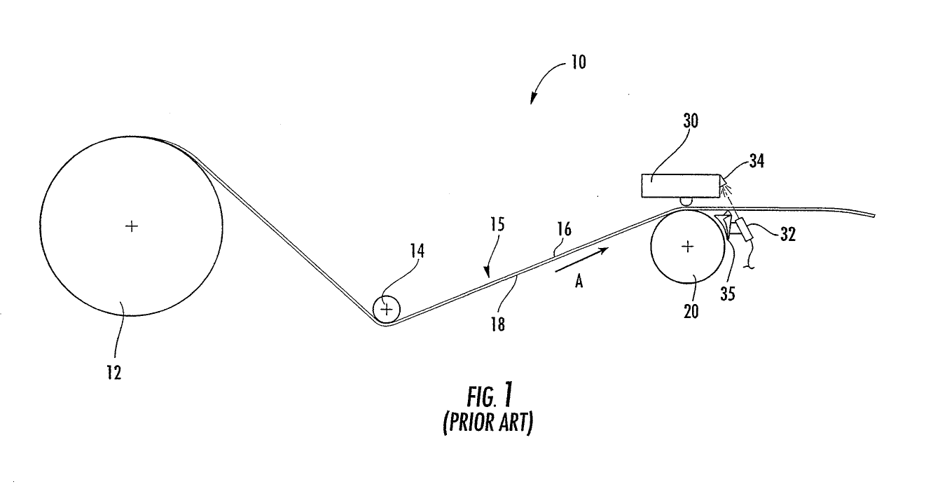

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

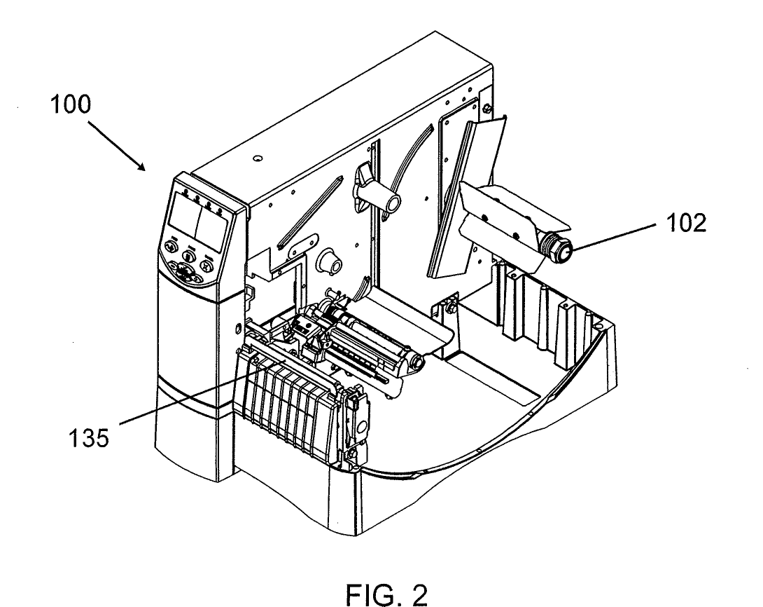

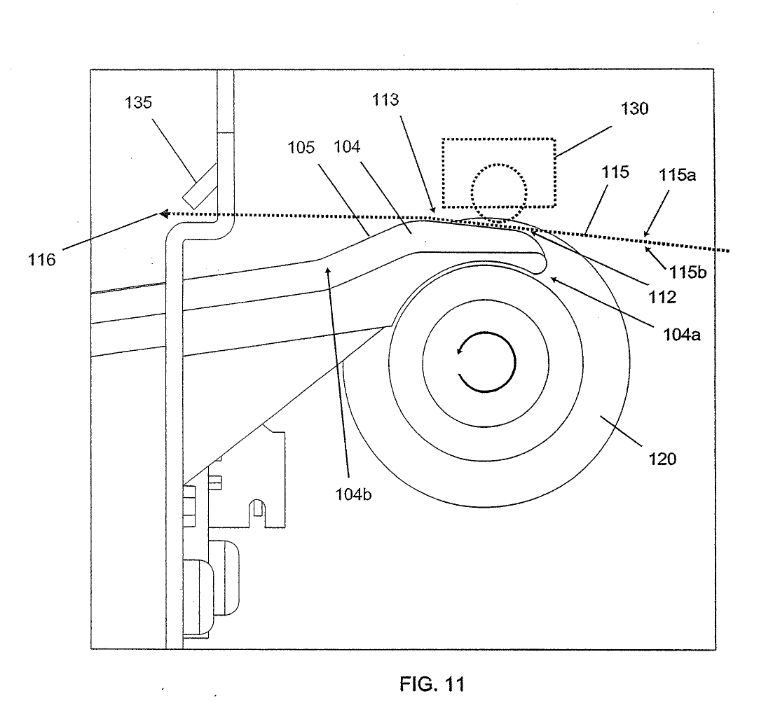

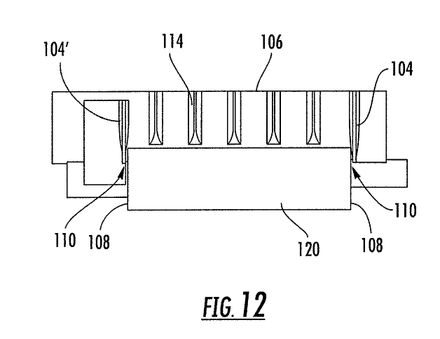

FIG. 2 is a perspective view of a printer 100 for printing linerless media in accordance with one embodiment of the present invention. As will be apparent to one of ordinary skill in the art, the printer 100 includes a support shaft 102 for receiving a linerless media supply such as a linerless label supply roll (not shown). The linerless media supply or linerless label supply typically consists of a wound roll of continuous linerless label media 115 (FIG. 11). The linerless label media 115 includes a printable surface 115a opposed by an adhesive surface 115b that is coated at least partially with a pressure sensitive adhesive. Unlike more conventional labels, linerless labels 115 do not have a release layer or liner covering their adhesive surface 115b that protects the label from pre-mature adhesion or contamination. Accordingly, in order to be usably wound on a supply spool, the printable surface 115a of the label media 115 can be coated with silicone or other similar materials so that the supply roll layers do not stick together.

In various embodiments of the present invention, the continuous web of linerless label media 115 is threaded through the printer 100 along a feed path between the linerless label supply roll (not shown) and a platen roller 120. The linerless label supply is biased to resist being drawn through the printer, thereby ensuring adequate tension remains in the label media throughout subsequent printing and backfeed processes. Depending upon the application, as known to one of ordinary skill in the art, the linerless label media 115 is threaded automatically or manually during loading. The platen roller 120 is configured to rotate in either direction for driving the linerless label 115 between various positions (e.g., registration position, print position, removal position, etc.). Unlike idler rollers or other tensioning devices that typically contact only the printable surface 115a of the label, the platen roller 120 is designed to contact the adhesive surface 115b of the label as shown. As a result, the platen roller 120 is typically coated with adhesive release materials such as silicone, plasma coating, or other similar materials known in the art. The platen roller 120 can be powered by one or more stepper motors (not shown) and controlled by a printer processor as discussed further below, such that the operation of the platen roller 120 effects the movement of the media 115.

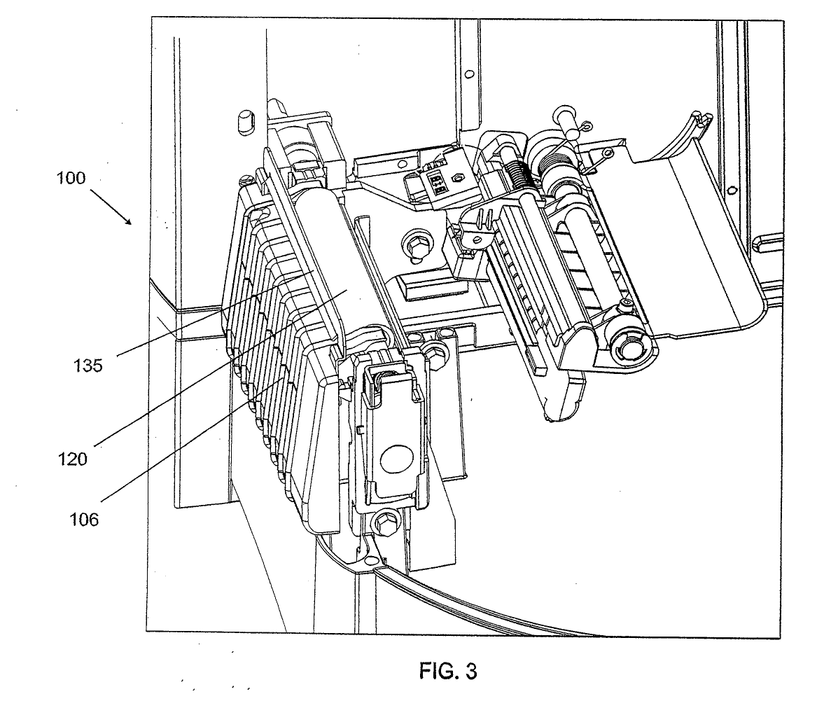

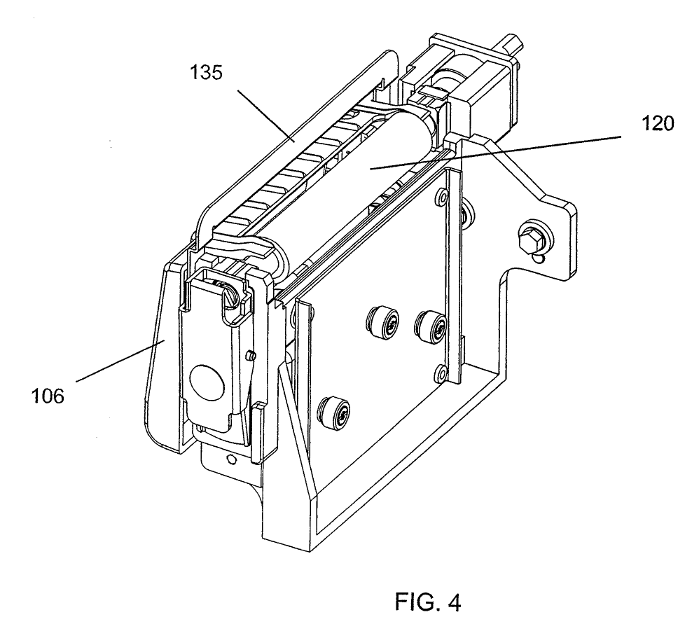

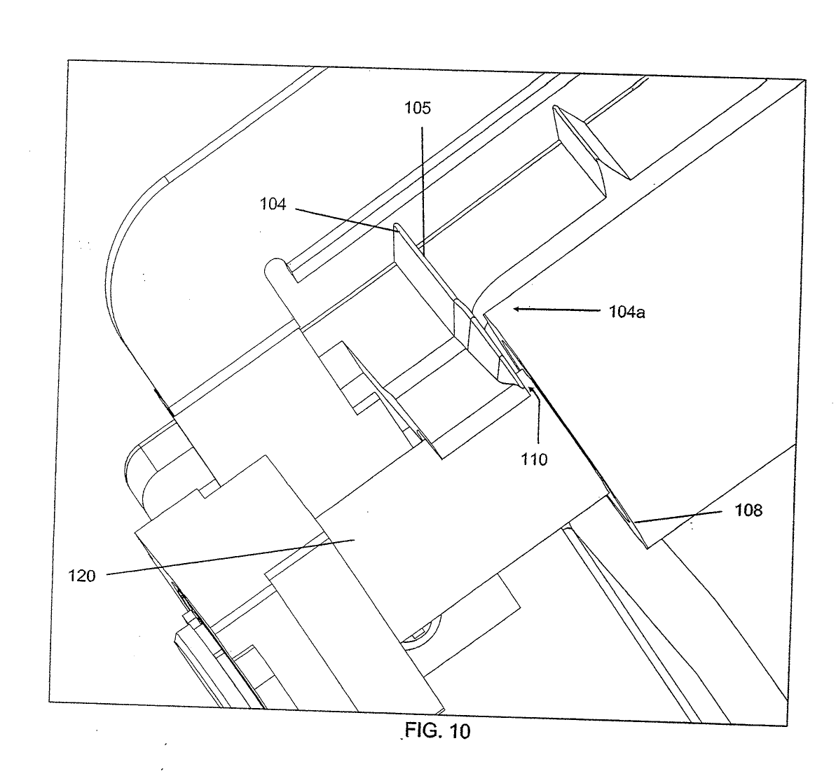

A print head 130 (shown schematically in dashed lines in FIG. 11) is generally provided above the platen roller 120 for printing an image to the linerless label media 115. For purposes of illustrative clarity, the printer 100 is shown without the print head 130 in FIGS. 2-10. As described above, the print head 130 engages and moderately compresses the linerless label 115 into the platen roller 120. This compression enhances print quality and in some applications maintains a sufficient tension along the linerless label media 115. Although not required, the print head 130 generally engages the platen roller 120 adjacent its apex as shown. For the purposes of the present invention and appended claims, the engagement position between the print head 130 and the platen roller 120 will be referred to as a print point. Similar to the platen roller above, the movement and operation of the print head 130 is controlled by the printer processor (not shown).

To print a batch of labels, an operator selects the indicia to be printed in addition to various label parameters such as format, quantity, etc. The processor receives this input from an interface (not shown) and engages the platen roller 120 and print head 130 to carry out the operator's requested print job. However, before the print job is carried out, the linerless label media 115 is typically advanced to a known registration position, e.g., so that the leading edge 116 (FIG. 11) of the media 115 is aligned with a tear bar 135. From this known position, the area of the label to be printed can be properly aligned according to the leading edge 116 of the media 115, or perhaps a perforation, in order to reduce waste. Upon occurrence of a trigger condition such as loading a label supply into the printer 100, providing power to the printer, closing the printer housing, etc., the linerless label 115 is typically advanced to a position in which the leading edge of the linerless label is positioned beyond the print point and the printer detects (generally through an optical sensor or the like) a registration mark disposed on the linerless label media 115. The platen roller 120 then reverses the linerless label media 115 a known distance until reaching a selected registration position. In other applications, as will be apparent to one of ordinary skill in the art, an optical sensor (not shown) may be disposed upstream of the platen roller 120 such that linerless media is advanced, rather than reversed, to a selected registration position upon detection of the media registration mark.

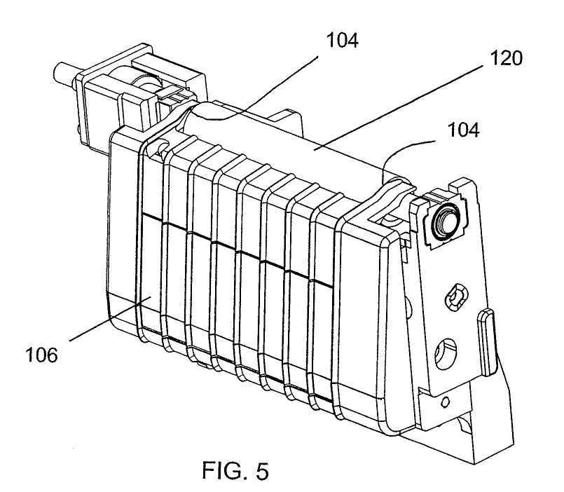

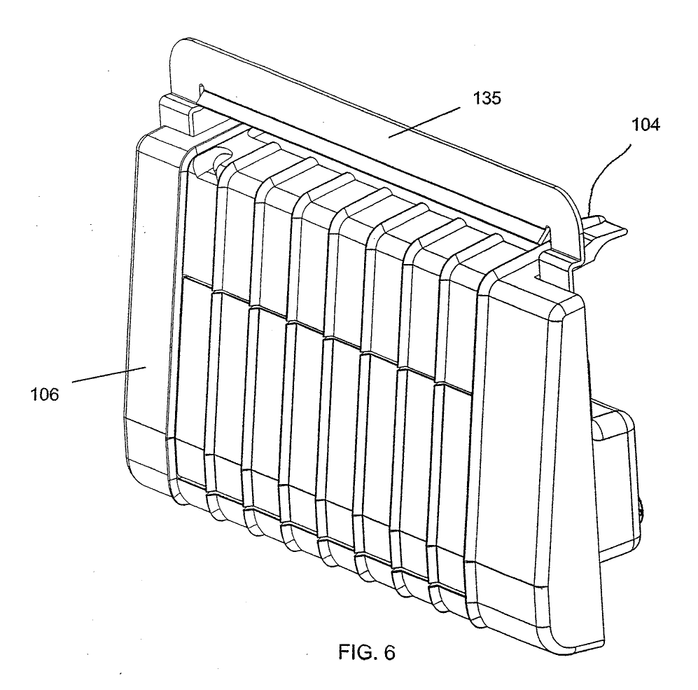

As illustrated in FIGS. 2-12, the printer 100 includes first and second support rails 104 that are disposed at opposite ends 108 of the platen roller 120 and support the linerless media 115 as the media is advanced along the feed path. The ends 108 of the platen roller 120 can be defined by shoulders thereof, and the shaft or other core of the platen roller can extend beyond the ends 108. The support rails 104 generally support opposite edges of the media 115 to prevent the media from wrapping around the platen roller 120. As shown, e.g., in FIGS. 5 and 6, the support rails 104 can be an integral part of a front face plate 106 that is disposed downstream of the platen roller 120, and the support rails 104 can guide the media 115 onto an outer surface of the face plate 106.

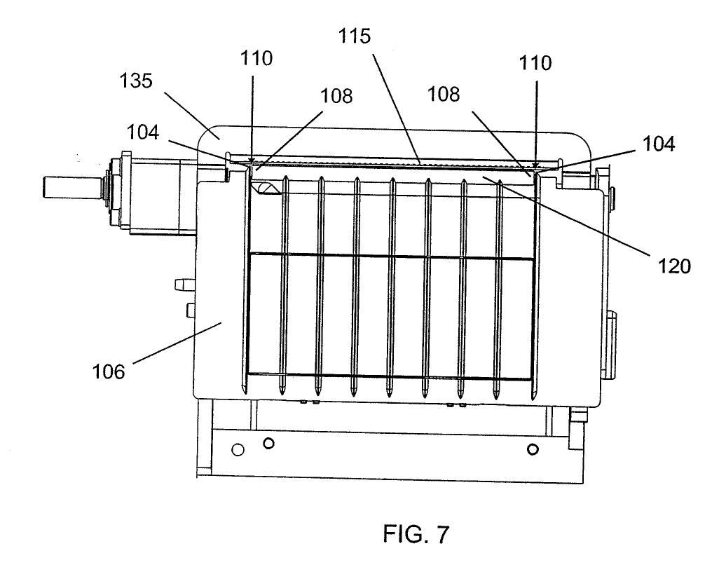

FIG. 7 illustrates the platen roller 120, support rails 104, and face plate 106 as seen from the front (downstream end) of the printer 100. The location of the media 115 is indicated by dashed lines in FIG. 7. As illustrated, the platen roller 120 defines a length between its ends 108 that is slightly shorter than the width of the media 115. Thus, the side edges of the media 115 are not supported by the platen roller 120. Instead, each of the edges is disposed between one of the rails 104 and the print head 130. As the media 115 is advanced through a nip defined between the platen roller 120 and the print head 130 with the printable surface 115a directed toward the print head 130 and the adhesive surface 115b directed toward the platen roller 120, the media 115 is supported by both the platen roller 120 and the rails 104.

The first rail 104 is disposed proximate the first end 108 of the platen roller 120, and the second rail 104 is disposed proximate the opposite, second end 108 of the platen roller 120. The rails 104 are generally stationary during operation. That is, although the rails 104 can be adjustable or otherwise movable during a configuration of the printer 100, the rails 104 do not rotate with the platen roller 120. A small gap 110 can be provided for clearance between each support rail 104 and the proximate end 108 of the platen roller 120, e.g., so that the rail 104 does not touch and rub against the end 108 of the platen roller 120.

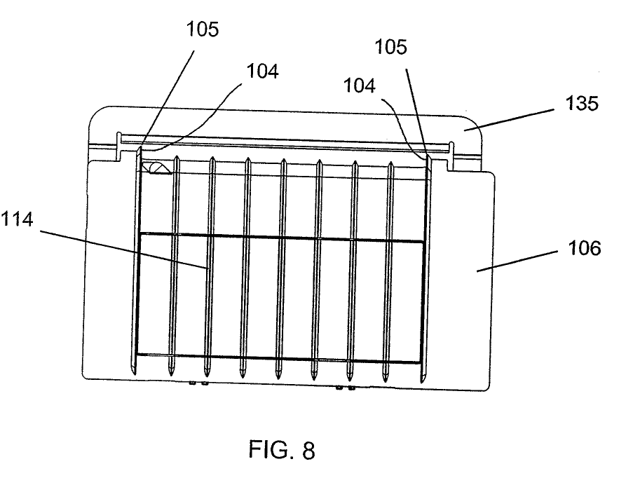

As shown in FIG. 8, each rail 104 defines a support surface 105 for contacting the media 115. The cross-sectional shape of the rail 104 can be tapered near the support surface 105. In particular, each rail 104 can taper in a direction toward the media 115 so that the support surface 105 of each rail 104 is defined as an edge, as illustrated in FIG. 8. The edge-like support surface 105 extends longitudinally in the direction of the feed path, e.g., perpendicular to the axis of the platen roller 120, so that the media 115 can slide along the edge with minimal friction as the media 115 is driven by, or otherwise transported against, the rotating platen roller 120. The support surfaces 105 can also be provided with a low-friction or adhesive release coating.

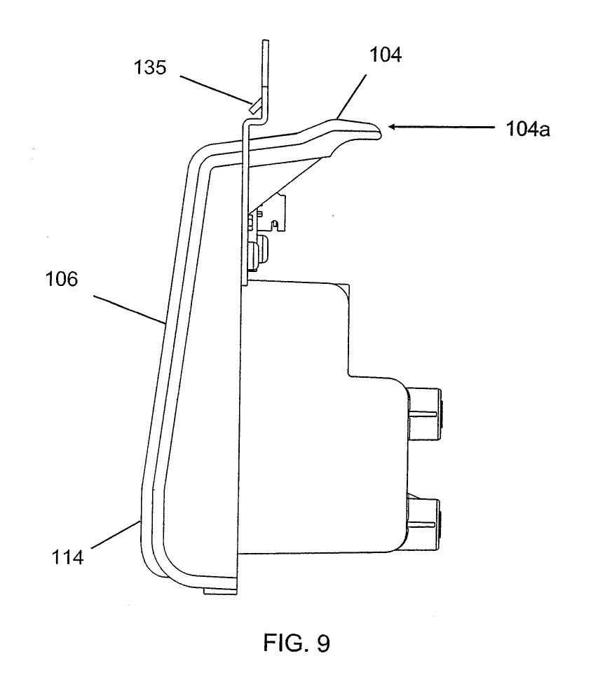

The profile of the rails 104 is shown in FIGS. 9-11. Each rail 104 typically is configured to extend from a first point that is located radially within the perimeter of the platen roller 120 to a second point that is located radially outside the perimeter of the platen roller 120. For example, as shown in FIG. 11, the rail 104 extends from a first end 104a that is radially within the cross-sectional profile of the platen roller 120. The platen roller 120 typically includes a rigid shaft at its core and an elastomeric outer layer. For example, the roller 120 can include a rigid, metal shaft with an elastomeric sleeve provided thereon, the elastomeric sleeve being shorter in length such that the shoulders of elastomeric sleeve define the ends 108 proximate to the rails 104. In operation, the print head 130 can be positioned to apply a compressive force against the platen roller 120 to thereby compress and deform the elastomeric outer layer in a deformation area 112, as indicated in FIG. 11, that includes the print point. The first end 104a of each rail 104, i.e., the upstream end, can be located radially within the outer surface of the platen roller 120, even when the platen roller 120 is compressed slightly by the print head 130. Thus, with regard to a line on the media 115 extending widthwise across the media 115, as the media 115 is advanced in the forward direction along the feed path, the line can contact the platen roller 120 before contacting the rails 104. The line on the media 115 then contacts both the platen roller 120 and the rails 104, until the line is guided off of the platen roller 120 by the rails 104 at a separation area 113. In this way, the platen roller 120 engages the media 115 and advances the media 115 onto the rails 104, and the rails 104 guide the media 115 off of the platen roller 120 and onto the face plate 106. With a second end 104b of the rails 104 positioned radially outside the perimeter of the platen roller 120, the second ends 104b of the rails 104 are disposed between the media 115 and the platen roller 120 to thereby prevent the media 115 from remaining stuck to the platen roller 120 past the separation area 113 and wrapping around the platen roller 120.

One or both of the support rails 104 can be formed integrally with the face plate 106. In particular, the support rails 104 and the face plate 106 can be formed as a single unitary, i.e., monolithic, member as illustrated in FIG. 6-8. For example, if the support rails 104 and face plate 106 are to be formed of plastic, both of the support rails 104 and the face plate 106 can be formed in a single plastic molding operation, such as an injection molding operation, or a single machining process.

Alternatively, one or both of the support rails 104 can be adjustable relative to the face plate 106. For example, one of the support rails 104 can be adjustably mounted relative to the face plate 106 so that a user can adjust the support rail 104 in a direction toward or away from the opposite support rail 104 to adjust the distance between the support rails 104. In particular, FIG. 12 illustrates an embodiment in which one rail 104′ is formed integrally with the face plate 106, and the other rail 104 is formed as a separate member that is adjustable relative to the face plate 106 and configured to be secured relative to the face plate 106 in various positions, i.e., to adjust the distance between the two rails 104 to accommodate media 115 of different widths. In this regard, the platen roller 120 can be removed and replaced with a platen roller 120 of a different length, such that the rail 104′ can be adjusted accordingly so that each rail 104, 104′ defines a small gap 110 relative to the platen roller 120.

In any case, the face plate 106 can define other structures or details for supporting the media 115. For example, the face plate 106 can define ridges or other rails 114 that extend downstream of the platen roller 120 for receiving the media 115 from the platen roller 120 and supporting the media 115 as the media 115 in a removal position, at which the printed label can be removed from the printer 100 by a user. The label is typically removed by tearing or otherwise separating the printed label from the media 115, e.g., by pulling the label upward toward the tear bar 135 and tearing the label against the tear bar 135.

In some embodiments of the present invention, the media 115 can be supported downstream of the platen roller 120 by other structures or devices. For example, a low-pressure air flow can be provided to buoyantly support the media 115 in a cantilevered orientation downstream of the platen roller 120, and/or a secondary roller or bumper can be disposed immediately downstream from the platen roller 120 for dislodging the printed linerless from the platen roller 120, as further described in U.S. patent application Ser. No. 11/443,791, filed Jun. 22, 2006, titled “Printer and Method for Supporting a Linerless Label,” the entirety of which is incorporated herein by reference.

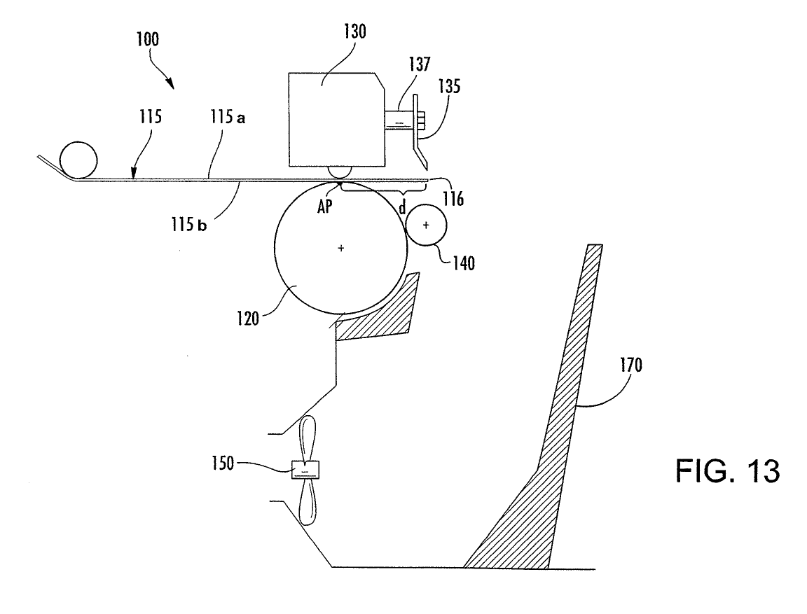

FIGS. 13-16 illustrate the use of air flow, secondary rollers, and bumpers for supporting the media 115 downstream of the platen roller 120. These aspects can optionally be used in combination with the rails 104 and/or face plate 106 of the present invention. For example, in FIG. 13, the media 115 is positioned in a registration position, i.e., a preset position wherein the leading edge 116 of the linerless label is spaced a distance d from the print point defined above between the print head 130 and the platen roller 120. The depicted registration position is set such that the leading edge 116 of the media 115 is generally aligned with a tear bar 135 or other cutting device such that the media 115 is automatically disposed in the registration position upon removal of a printed label by an operator. Notably, other methods of registration are commonly known in the art and the inventive concepts herein described are not limited to any one method of registration.

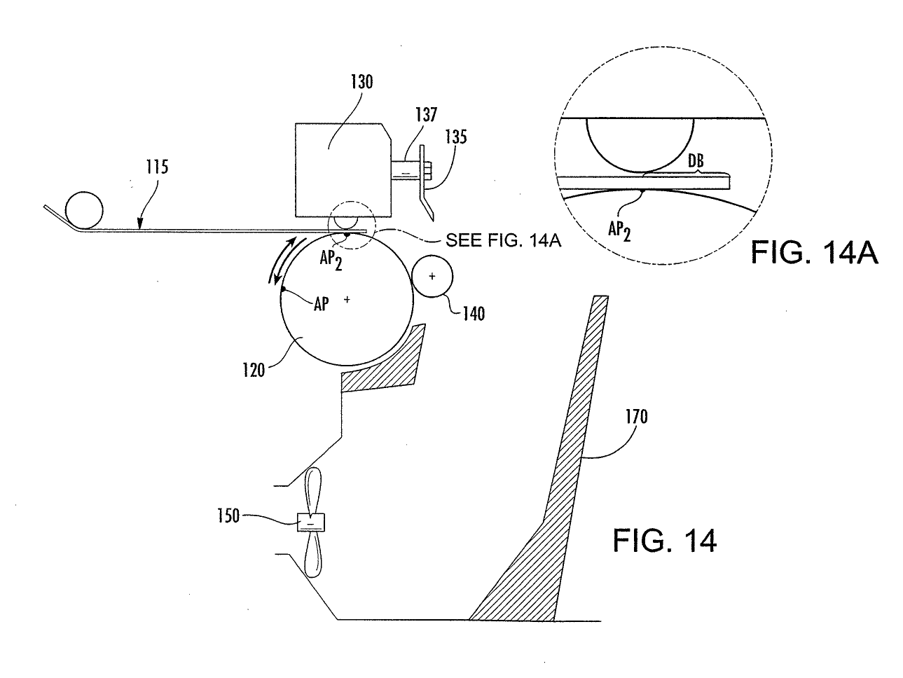

If a print job is not imminent, the linerless label media 115 may remain in the registration position for a period of time. In the depicted embodiment of FIGS. 13-16, the registration position is calibrated with the desired label length such that the leading edge of the label is positioned generally under the tear bar 135 as shown. In relatively new printers, this registration position delay may not cause difficulty; however, in heavily used printers where the no-stick characteristics of the platen roller 120 has begun to wear out, this delay may cause partial adhesion between the linerless label 115 and the platen roller 120 at adhesion point AP. Immediately prior to printing, this adhesion is dislodged by a backfeed operation wherein the platen roller 120 abruptly reverses the linerless label media 115 to a print position illustrated in FIG. 14. In the print position, the leading edge 116 of the linerless label media 115 is generally positioned adjacent to, or just downstream from, the print point defined between the print head 130 and platen roller 120. As a result, individual labels are accurately printed onto the web of linerless label media 115 with relatively little wasted material. In the depicted embodiment, the leading edge 116 of the linerless label media is positioned a distance DB downstream of the print position as shown in the detail view provided by FIG. 14A. This distance DB is commonly referred to as a “dead band” and may operate to reduce the likelihood that the leading edge of the linerless label will adhere to the platen roller 120 as will be apparent to one of ordinary skill in the art. In various embodiments, the distance may be less than 0.75 inches, preferably less than 0.5 inches, and more preferably approximately 0.2 inches.

Upon reaching the print position, it is desirable for the print head 130 to begin printing and for the linerless label 115 to simultaneously begin its advance. The relatively prompt advancement of the linerless label 115, which is driven by the platen roller 120, reduces the likelihood that a second adhesion point AP₂ will form between the linerless label 115 and the platen roller 120 as shown in FIG. 14. If left to develop, this second adhesion point AP₂ could cause the printed linerless label to wrap around the platen roller 120, thus, jamming the printer.

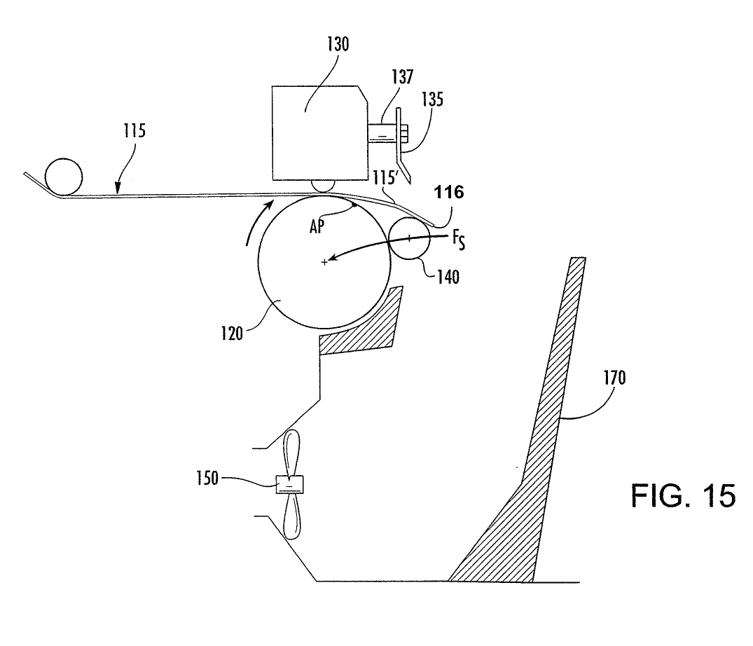

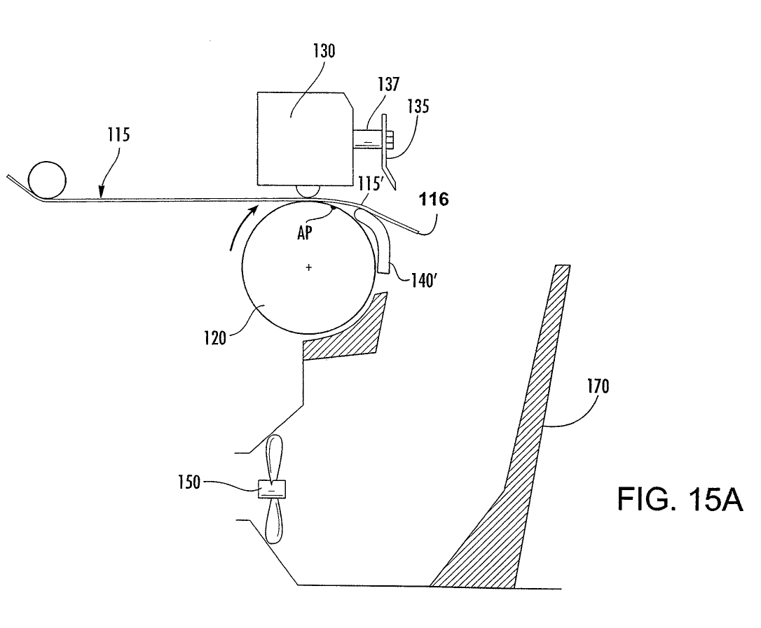

As the platen roller 120 drives the label media 115 forward during printing, adhesive residue proximate the adhesion point AP remaining on the platen roller 120 or previously disturbed adhesive on the media itself may cause the printed linerless label 115′ to advance slightly downwardly around the platen roller 120 as depicted in FIG. 15. Additional adhesion possibly occurring at AP₂ may also cause the media to advance slightly downward. Notably, any dead band DB provided during printing aids in preventing adhesion between the platen roller 120 and the leading edge 116 of the label media and, thus, the leading edge 116 of the printed label 115′ remains spaced from the platen 120 as shown.

In some embodiments, to prevent further wrapping of the linerless label 115, a secondary roller 140 may be provided adjacent the platen roller 120 as shown. The secondary roller 140 may be formed from a polymer, wood, rubber, metal, or other similar materials. For example, the secondary roller may be comprised of a Tetrafluoroethylene (“TFE”) material such as Rulon®. In the depicted embodiment, the secondary roller 140 is considerably smaller in diameter than the platen roller 120. In some embodiments, the secondary roller 140 may be configured to approach the platen roller 120 without adversely contacting or obstructing the rotation of the platen roller 120. The depicted secondary roller 140 is biased along force direction FS to lightly contact the platen roller 120 and is thus designed to rotate with the platen roller 120.

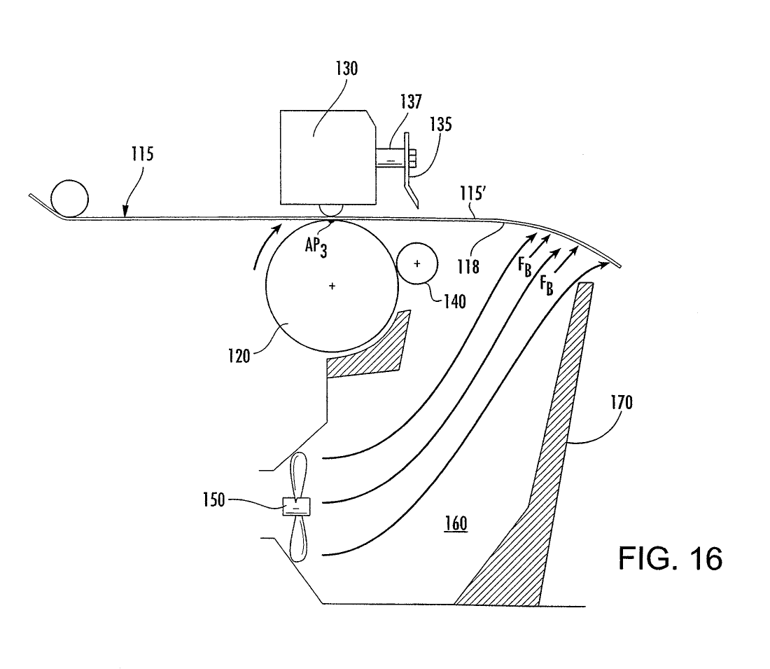

As the printed linerless label 115′ is advanced by the platen roller 120, the leading edge 116 of the printed label 115′ may extend over the secondary roller 140. In one embodiment, the periphery of the secondary roller 140 is coated with non-stick materials of the type described above, which prevent adhesion between the printed linerless label 115′ and the secondary roller 140. Other adhesion reducing techniques known in the art may be used such as structuring the secondary roller 140 to have a scalloped periphery. As the printed linerless label 115′ advances over the secondary roller 140, the rotation of the platen roller 120 and the relative stiffness of the printed label 115′ mechanically dislodge adhesion occurring between the linerless label 115 and platen roller 120. As a result, the printed linerless label 115′ is free to extend generally horizontally from the platen roller 120 in a removal position as illustrated in FIG. 16.

As noted above, the depicted secondary roller 140 is spring biased to lightly contact the platen roller 120. In such embodiments, the secondary roller 140 may be moved against its position bias (e.g., spring tension, etc.) away from the platen roller 120 in a direction generally opposite to arrow Fₛ. This mobility allows for an operator to conveniently access the platen roller 120 in the event of platen malfunction and/or other printer servicing.

In yet another embodiment of the present invention, the secondary roller may be replaced by other adhesion detaching structures such as the bumper 140′ shown in FIG. 15A. The bumper 140′ may be comprised of a flexible polymer, rubber, or other similar material. The bumper 140′ may define a textured surface and may be coated with silicone oil or other similar non-stick coatings. In the depicted embodiment, the bumper 140′ defines an arcuate shape as shown. However, other shapes may be adopted to perform the adhesion detaching function described herein as will be apparent to one of ordinary skill in the art in view of this disclosure. In one embodiment, the bumper 140′ may define a vertically scalloped exterior surface that is structured to reduce the surface area of the bumper 140′ that actually contacts the linerless media 115 and thereby reduces the potential for adhesion between the bumper 140′ and the linerless media 115. In various embodiments, the bumper 140′ may be coated with non-stick materials of the type described above.

As described above with regard to the secondary roller, the bumper 140′ may be spring biased to lightly contact the platen roller 120. In this regard, the bumper 140′ may be moved against its position bias (e.g., spring tension, etc.) away from the platen roller 120 in a direction generally opposite to arrow FS (of FIG. 15). This mobility allows for an operator to conveniently access the platen roller 120 in the event of platen malfunction and/or other printer servicing. In other embodiments, this mobility may be provided by or enhanced by a bumper 140′ comprised of flexible or elastic materials. As will be appreciated by one of ordinary skill in the art, bumpers structured in accordance with various embodiments of the invention may be positioned relatively close to the print head 130 thereby allowing a reduction in dead band length.

In another embodiment of the present invention, the printed linerless label 115′ is buoyantly supported in this generally cantilevered or extended orientation in the removal position by an air flow 155 produced by a flow device 150. Accordingly, the problems discussed above that are associated with conventional linerless label printers, e.g., drooping or sagging of the printed linerless label 115′ in the removal position, are thus overcome.

Unlike conventional air knives, which direct a high-pressure stream of air (typically between 20-50 p.s.i.) between a printed linerless label and the platen roller to dislodge adhesion occurring therebetween, the present invention provides a flow device 150 that directs a low-pressure flow of air upwardly from the flow device 150 to buoyantly support a printed linerless label 115′ in a generally cantilevered removal position. In various embodiments, the low-pressure flow of air is between 0-5 p.s.i, preferably between 0-2 p.s.i., and more preferably less than 1 p.s.i. At such pressures, the printed linerless label is buoyantly supported in a substantially cantilevered or extended removal position and, thus, may be readily sensed by a label retrieval sensor (e.g., optical sensor, etc.) and easily removed by an operator. For purposes of the present specification and appended claims the term “cantilevered or extended” orientation refers a linerless label position whereby the linerless label is supported at a proximal end by printer components (e.g., platen roller, etc.) and supported at a distal end only by the low pressure flow produced by the flow device.

As will be apparent to one of skill in the art, conventional high pressure air knives are not desirable in the structure adapted by various embodiments of the present invention as such devices would produce a high pressure air stream that could fold or otherwise damage the printed linerless label 115′. High pressure air knives would likely also prevent the label from being properly substantially horizontally presented to the operator and could possibly injure the operator by hurling loose particulate upwardly, toward the operator, at relatively high speeds. Further, high pressure air streams may drive the printed label 115′ severely upwardly to jam against components secured above the printed label 115′ such as the depicted tear bar 135.

In one embodiment of the present invention, the flow device 150 may be an exhaust fan that is traditionally used to cool various internal printer components. In other embodiments, a fan dedicated solely to printed label support (not shown) may be used. In still other embodiments, low-pressure air jets, low-pressure pneumatic cylinders or other similar devices structured to produce a low-pressure flow of air or other gases for buoyantly supporting a linerless label may be used. In one embodiment, the printer 100 includes a channel 160 that directs the air flow 155 produced by the fan 150 upwardly, toward the adhesive surface of the printed linerless label 115′ as shown in FIG. 16. The channel 160 route may be defined, at least partially, by one or more deflectors 170 as shown. In various embodiments, the deflectors 170 may include standard pieces, such as portions of the external housing of the printer, or alternatively, may include specifically designed shrouds, chambers or ramps positioned adjacent the fan 150 for deflecting the air flow 155 toward the printed portion of the linerless label 115′. Further, in other embodiments, one or more air ducts or hoses (not shown) may be provided to route the air flow 155 from any position within the printer as will be apparent to one of ordinary skill in the art. Accordingly, the fans or flow devices 150 may be strategically positioned in a variety of locations within the printer based on other design considerations and need not be positioned generally below the platen roller 120 as shown.

In other embodiments, various conventional printer components may be relocated to a position above the printed linerless label 115′ for reducing possible obstruction of the upwardly directed air flow 155. For example, in one embodiment, a tear bar 135 is relocated from a conventional position below the linerless label 115′ to a position above the label 115′. The tear bar 135 provides an edge for assisting an operator to uniformly tear a printed label 115′ from the web of linerless label media 115. As will be apparent to one of ordinary skill in the art, an operator removes the printed linerless label 115′ by grasping the label and pulling upwardly against the tear bar 135. In various embodiments, the linerless label 115′ may include one or more perforations that are alignable with the tear bar 135 such that the label may be removed in an efficient and uniform fashion. By placing the tear bar 135 above the printed linerless label 115′, rather than below, the tear bar 135 and its support structures do not obstruct the free flow of air to the printed linerless label 115′. In other embodiments, label sensors (not shown) and other similar components may be removed from beneath the printed linerless label 115′ as will be apparent to one of ordinary skill in the art in view of the above disclosure.

In still another embodiment, the tear bar 135 is supported a distance downstream of the print position by a tear bar extension 137. In various embodiments, linerless label printers may be configured as “on-demand” printers wherein individual labels are printed as they are retrieved by an operator. Thus, the printed linerless labels 115′ are prone to resting for prolonged intervals in the removal position illustrated in FIG. 16. As described above, such rest periods may cause partial adhesion between the linerless label media 115 and the platen roller 120 at adhesion point AP₃. By positioning the tear bar 135 a distance downstream of the print position, the label media 115′ is properly positioned for a robust backfeed operation to occur once the printed linerless label 115′ has been removed or otherwise when desired. As will be apparent to one of ordinary skill in the art, this backfeed operation is generally similar to that described above with regard to registration of the linerless label media 115. Although various embodiments referenced above have been described and depicted employing a tear bar, additional embodiments may use a similarly oriented cutter or other similar device as will be apparent to one of ordinary skill in the art in view of the above disclosure.

Still another embodiment of the present invention is directed to a back-winding media supply spindle. As noted above, conventional linerless printers may employ a frictioning device to bias the printer's media supply against forward motion or advancement of the linerless media by the platen roller. This biasing against forward motion helps to deter the linerless printing media from unwinding excessively, sagging, and adhering in the printer's internal media path.

Unlike conventional frictioning devices that simply oppose forward motion of the media supply (i.e., unwinding of the media from the supply), the back-winding media supply spindle applies a relatively continuous back tension of approximately 300 to 500 grams to the media web between the media supply roll and the platen/print head nip. In one embodiment, this tension is present during forward movement of the media, during backward movement of the media (i.e., during backfeed), and while the media is at rest. This tension may prevent the linerless media from sagging and adhering to the printer's internal media path. In contrast to prior art devices, the back-winding media supply spindle may also operate in conjunction with a robust back feed (e.g., a backfeed distance of approximately 0.5 inches or greater) to physically break adhesion that may have developed between the linerless media and the platen at location AP (shown in FIG. 13).

As will be apparent to one of ordinary skill in the art, without the disclosed back-winding media supply spindle, the linerless media may remain adhered at location AP and, thus, simply back-wrap around the platen roller during backfeed operations. Should this occur, the media may remain adhered to the platen roller through the printer's subsequent forward printing motion and may increase the chance that the linerless media will be drawn forwardly around the platen thereby jamming the printer.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A printer for advancing a linerless media along a feed path through the printer and printing on a printable surface of the linerless media opposite an adhesive surface of the linerless media, the printer comprising:
a print head disposed along the feed path and configured to print on the printable surface of the linerless media;
a rotatable platen roller configured to define a nip with the print head for receiving the linerless media, the platen roller extending longitudinally between first and second ends and defining an outer surface configured to engage the adhesive surface of the linerless media; and
a first support rail disposed proximate the first end of the platen roller, and a second support rail disposed proximate the second end of the platen roller, each of the support rails extending longitudinally in the direction of the feed path and defining a stationary support surface for supporting the linerless media, the support surface of each support rail being configured to slidably support the media when the media is engaged to the platen roller and moving along the feed path.

2. A printer according to claim 1, wherein each support rail defines a tapering cross-sectional shape such that each support surface is an edge extending in the direction of the feed path.

3. A printer according to claim 1, wherein the platen roller defines a length between the first and second ends that is shorter than a width of the linerless media.

4. A printer according to claim 1, wherein each support rail extends longitudinally along the feed path to a face plate downstream of the platen roller such that the rails guide the media onto the face plate.

5. A printer according to claim 1, wherein the platen roller is configured to rotate and drive the linerless media along the feed path.

6. A printer according to claim 1, further comprising a flow device structured to provide a low-pressure flow that buoyantly supports the linerless media in a cantilevered orientation downstream of the platen roller.

7. A printer according to claim 1, further comprising at least one of a secondary roller and a bumper disposed immediately downstream from the platen roller for dislodging the printed linerless from the platen roller.

8. A printer according to claim 4, wherein at least one of the support rails is formed integrally with the face plate.

9. A printer according to claim 1, wherein at least one of the support rails is adjustably mounted such that the distance between the support rails can be adjusted to accommodate various widths of media.

10. A platen support device for contacting an adhesive surface of a linerless media in a printer, the platen support device comprising:
a platen roller configured to rotate about a longitudinal axis, the platen roller extending longitudinally in the direction of the axis between first and second ends and defining an outer surface configured to engage the adhesive surface of the linerless media; and
first and second support rails, the first support rail disposed proximate the first end of the platen roller, and the second support rail disposed proximate the second end of the platen roller, each of the support rails extending in a direction perpendicular to the axis of the platen roller and defining a support surface for supporting the linerless media.

11. A method of operating a printer with a linerless media having a first side defining a printable surface and an opposite side defining an adhesive surface, the method comprising:
providing a rotatable platen roller along a feed path of the printer, the platen roller extending longitudinally between first and second ends;
providing a first support rail at the first end of the platen roller and a second support rail at the second end of the platen roller, each of the support rails extending longitudinally in the direction of the feed path and defining a support surface for supporting the linerless media; and
advancing the linerless media along the feed path such that the adhesive surface contacts an outer surface of the platen roller as opposite edges of the linerless media slide against the support surfaces.

12. A method of claim 11, wherein said advancing step comprises advancing the linerless media through a nip defined between the rotatable platen roller and a print head and printing on the printable surface with the print head.

13. A method of claim 11, wherein said step of providing the support rails comprises providing each support rail with a tapering cross-sectional shape such that each support surface defines an edge extending in the direction of the feed path.

14. A method of claim 11, wherein said step of advancing the media comprises advancing the media along the support rails to a face plate downstream of the platen roller and adjacent the rails such that the rails guide the media onto the face plate.

15. A method of claim 11, wherein said advancing step comprises rotating the platen roller such that the platen roller thereby drives the linerless media along the feed path.

16. A method of claim 11, further comprising buoyantly supporting the linerless media downstream of the platen roller via a low-pressure flow directed to contact the adhesive surface of the linerless media.

17. A method according to claim 11, wherein said advancing step comprises advancing the linerless media past the platen roller and dislodging the linerless media from the platen roller using at least one of a secondary roller and a bumper disposed immediately downstream from the platen roller.
